(19) United States
(12) Patent Application Publication
(10) Pub. No.: US 2021/0031338 A1
(43) Pub. Date: Feb. 4, 2021

(54) Switch Structure of Hand Tool

(71) Applicant: Chun Po Huang, Changhua City (TW)

(72) Inventor: Chun Po Huang, Changhua City (TW)

(21) Appl. No.: 16/815,352

(22) Filed: Mar. 11, 2020

(30) Foreign Application Priority Data
Jul. 31, 2019 (TW) 108210025

(51) Int. Cl. B25B 23/00; B25B 23/142; B25B 13/06

(52) U.S. Cl. CPC B25B 23/0007; B25B 23/0035; B25B 13/06; B25B 23/1427

(57) ABSTRACT

A switch structure of a hand tool contains: a body including an accommodation tube, a drive member, and a torque adjustment mechanism. The drive member is rotated in a first end of the accommodation tube, and the torque adjustment mechanism is arranged on a second end of the accommodation tube and abuts against the drive member so as to adjust a desired torque value. The drive member includes a positioning element extending from a second end of the drive member, and the positioning element has an outer diameter more than an outer diameter of the accommodation tube, the positioning element further has an engagement face formed on a first surface of the positioning element adjacent to the drive member. A control sleeve is fitted with the first end of the accommodation tube and is moved to a unlock position or a lock position by a user.

### FIELD OF THE INVENTION

The present invention relates to a switch structure which contains a control sleeve moved to an unlock position or a lock position so as to operate a hand tool as a torque wrench or a fixed wrench based on using requirements.

### BACKGROUND OF THE INVENTION

A conventional torque wrench is disclosed in TW Filing No. 106105035 and contains a body. The body includes a drive member mounted in a first end thereof and a torque adjustment mechanism arranged on a second end of the body. The drive member is rotatably connected in the first end of the body and abuts against the torque adjustment mechanism. The torque adjustment mechanism is configured to adjust a predetermined torque value. When the drive member locks a screw element, and an operated torque values reaches the predetermined toques value, the drive member rotates to an angle so that the torque adjustment mechanism makes a sound like “click” to remind a user, thus stopping rotating the torque wrench.

However, the torque wrench cannot be used to unlock the screw element. In other words, the screw element is unlocked by a fixed wrench.

The present invention has arisen to mitigate and/or obviate the afore-described disadvantages.

### SUMMARY OF THE INVENTION

One aspect of the present invention is to provide a switch structure of a hand tool which contains a control sleeve moved to an unlock position or a lock position so as to operate a hand tool as a torque wrench or a fixed wrench based on using requirements.

Another aspect of the present invention is to provide a switch structure of a hand tool which contains a torque adjustment mechanism arranged on an accommodation tube and abuts against a drive member so as to adjust a desired torque value of the hand tool.

To obtain the above aspect, a switch structure of a hand tool provided by the present invention contains: a body including an accommodation tube, a drive member, and a torque adjustment mechanism.

The drive member is rotated in a first end of the accommodation tube, and the torque adjustment mechanism is arranged on a second end of the accommodation tube and abuts against the drive member so as to adjust a desired torque value.

The drive member includes a positioning element extending from a second end of the drive member, and the positioning element has an outer diameter more than an outer diameter of the accommodation tube, the positioning element further has an engagement face formed on a first surface of the positioning element adjacent to the drive member.

A control sleeve is fitted with the first end of the accommodation tube and is moved to a unlock position or a lock position by a user.

When the control sleeve is fixed on the unlock position, a first end of the control sleeve is away from the engagement face so that the drive member is rotated to a desired angle, and the body is operated as a torque wrench.

When the control sleeve is fixed on the lock position, the first end of the control sleeve abuts against the engagement face so that the drive member is not rotated, and the body is operated as a fixed wrench.

### BRIEF DESCRIPTION OF THE DRAWINGS

FIG. 1 is a perspective view showing the exploded components of a switch structure of a hand tool according to a first embodiment of the present invention.

FIG. 2 is a perspective view showing the assembly components of the switch structure of the hand tool according to the first embodiment of the present invention.

FIG. 3 is a cross sectional view showing the operation of the switch structure of the hand tool according to the first embodiment of the present invention.

FIG. 4 is a perspective view showing the operation of the switch structure of the hand tool according to the first embodiment of the present invention.

FIG. 5 is another cross sectional view showing the operation of the switch structure of the hand tool according to the first embodiment of the present invention.

FIG. 6 is a side plan view showing the operation of the switch structure of the hand tool according to a second embodiment of the present invention.

FIG. 7 is another side plan view showing the operation of the switch structure of the hand tool according to the second embodiment of the present invention.

FIG. 8 is a cross sectional view showing the operation of the switch structure of the hand tool according to a second embodiment of the present invention.

FIG. 9 is another cross sectional view showing the operation of the switch structure of the hand tool according to the second embodiment of the present invention.

### DETAILED DESCRIPTION OF THE PREFERRED EMBODIMENTS

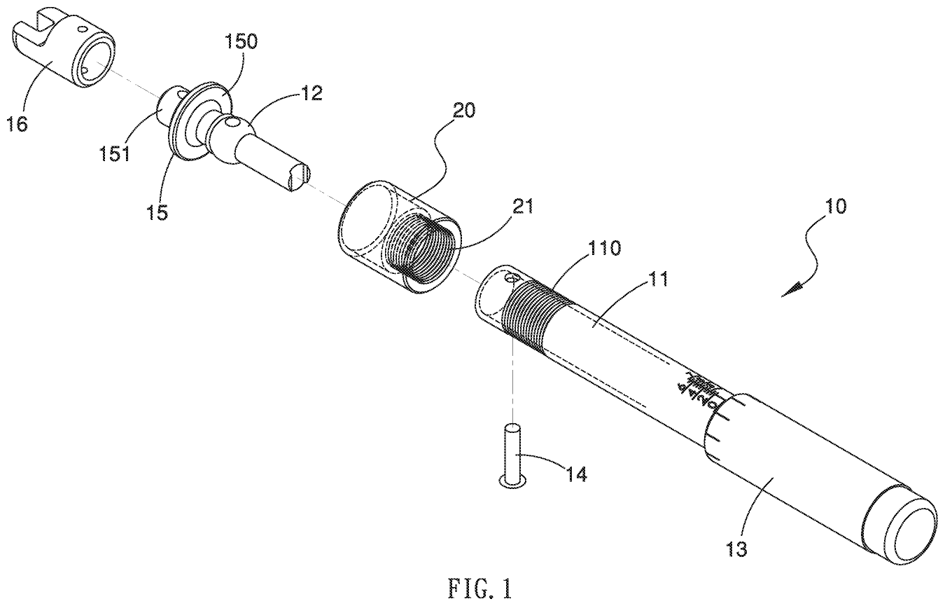

With reference to FIGS. 1 to 5, a switch structure of a hand tool according to a first embodiment of the present invention comprises: a body 10 and a control sleeve 20.

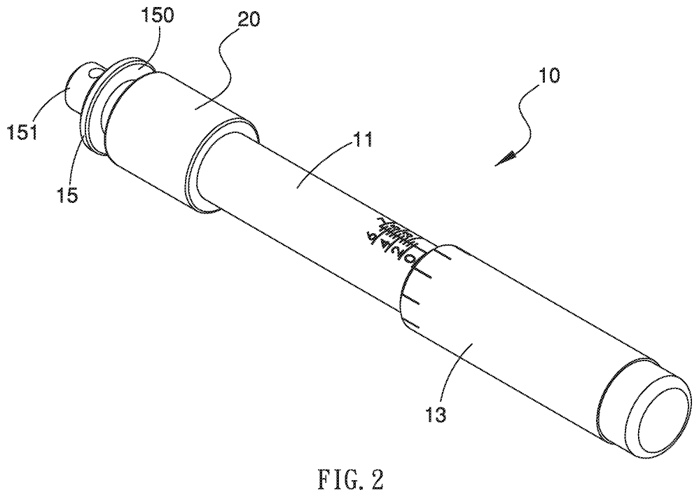

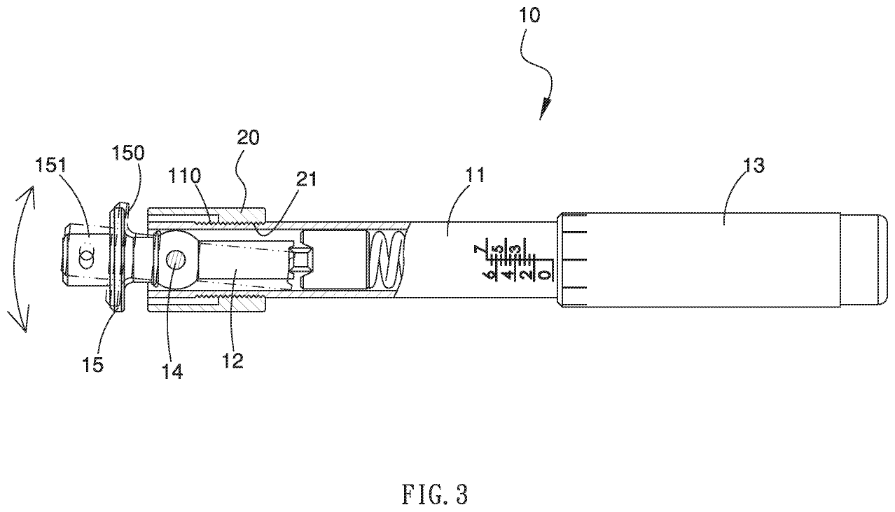

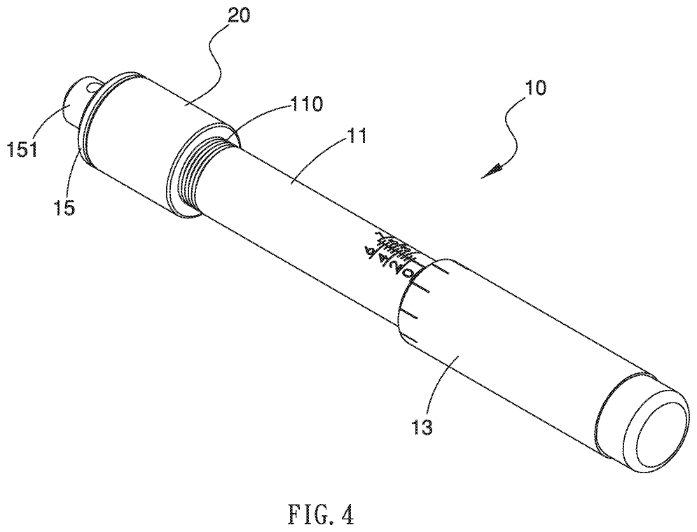

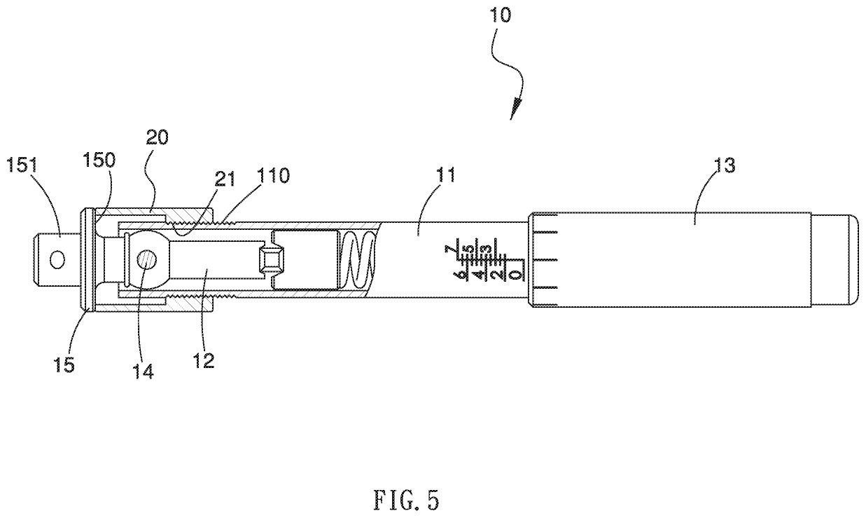

The body 10 includes an accommodation tube 11, a drive member 12, and a torque adjustment mechanism 13. A first end of the drive member 12 is inserted into a first end of the accommodation tube 11 and is rotatably fixed in the accommodated tube 11 by a connection bolt 14 so that the drive member 12 is rotated to a desired angle in the first end of the accommodation tube 11. The drive member 12 includes a positioning element 15 extending from a second end of the drive member 12, wherein the positioning element 15 has an outer diameter more than an outer diameter of the accommodation tube 11, an engagement face 150 formed on a first surface of the positioning element 15 adjacent to the drive member 12, and an actuation extension 151 arranged on a second surface of the positioning element 15 away from the drive member 12. The actuation extension 15 is formed in a column configured to engage with a socket 16. Alternatively, the actuation extension 151 is a drive head or a ratchet head of the torque wrench. The column is circular, rectangular or is formed in a D shaped so as to match with the socket 16. The torque adjustment mechanism 13 is arranged on a second end of the accommodation tube 11 and abuts against the drive member 12 so as to adjust a desired torque value. The control sleeve 20 is fitted with the first end of the accommodation tube 11 and is moved to a unlock position or a lock position by a user. When the control sleeve 20 is fixed on the unlock position, a first end of the control sleeve 20 is away from the engagement face 150 so that the drive member 12 is rotated to the desired angle, and the body 10 is operated as a torque wrench, as shown in FIGS. 2 and 3. When the control sleeve 20 is fixed on the lock position, the first end of the control sleeve 20 abuts against the engagement face 150 so that the drive member 12 is not rotated, and the body 10 is operated as a fixed wrench, as illustrated in FIGS. 4 and 5.

The accommodation tube 11 includes an outer threaded portion 110 formed the first end thereof, and the control sleeve 20 includes an inner threaded portion 21 formed on an inner wall thereof and configured to screw with the outer threaded portion 110, such that the control sleeve 20 is moved to the unlock position or the lock position.

Thereby, the control sleeve 20 is moved to the unlock position or the lock position so as to operate the hand tool as a torque wrench or a fixed wrench based on using requirements.

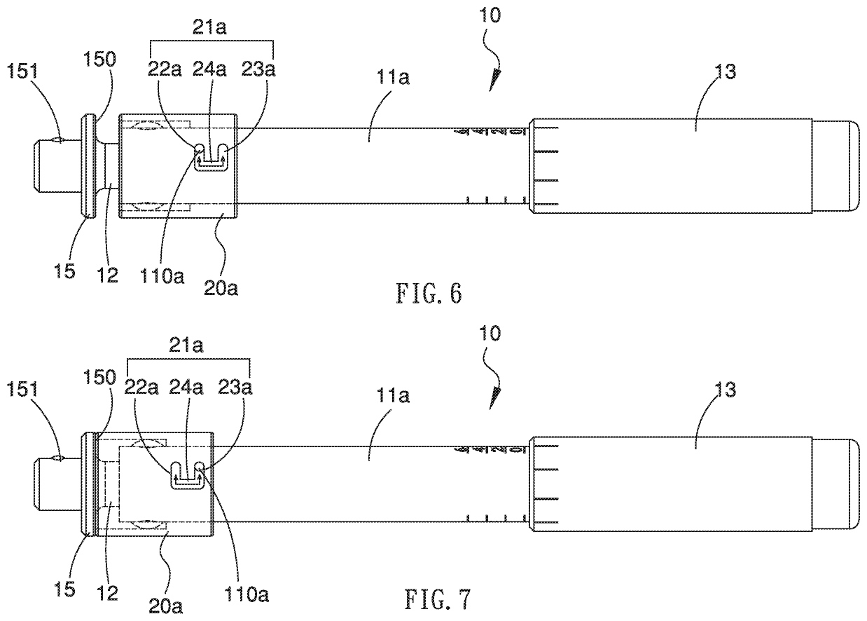

Referring to FIGS. 6 and 7, a difference of a switch structure of a second embodiment of the present invention from that of the first embodiment comprises: a body 10 and a control sleeve 20a.

The control sleeve 20a includes a fixing groove 21a in which a first retaining section 22a, a second retaining section 23a, and a connection section 24a configured to connect with the first retaining section 22a and the second retaining section 23a are formed. The body 10 includes an accommodation tube 11a on which a defining bolt 110a slides, and the defining bolt 110 is inserted into the fixing groove 21a. When the defining bolt 110a slides to the first retaining section 22a, the control sleeve 20a is located on the unlock position. When the defining bolt 110a slides to the second retaining section 23a, the control sleeve 20a is located on the lock position. In another embodiment, the fixing groove 21a is defined on the accommodation tube 11a, and the defining bolt 110a is mounted on the control sleeve 20a.

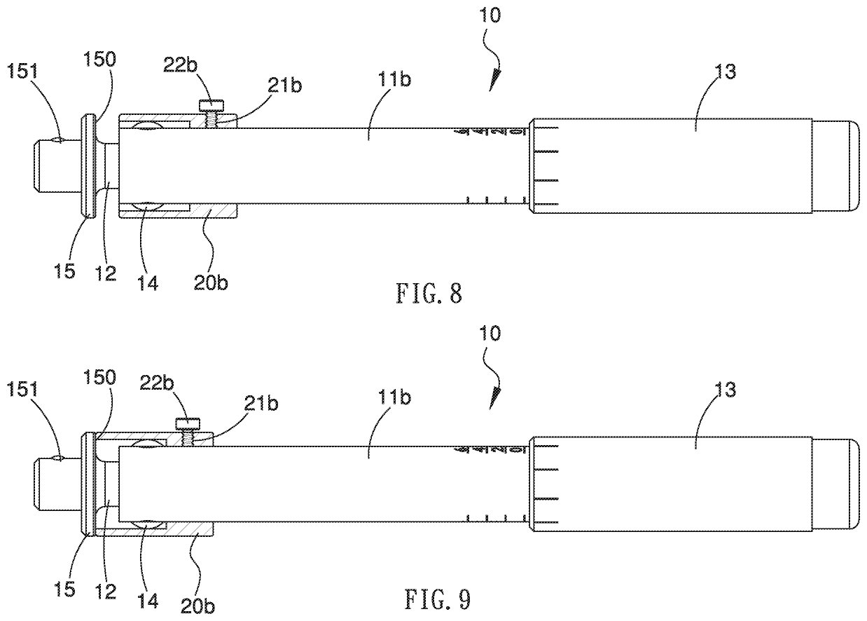

As shown in FIGS. 8 and 9, a difference of a switch structure of a third embodiment of the present invention from that of the first embodiment comprises: a body 10 and a control sleeve 20b.

The control sleeve 20b includes a threaded orifice 21b configured to screw with a screw bolt 22b, wherein the screw bolt 22b contacts with an accommodation tube 11b so as to be rotated loosely or tightly, such that the control sleeve 20 is moved to the unlock position or the lock position.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A switch structure of a hand tool comprising:
a body including an accommodation tube, a drive member, and a torque adjustment mechanism;
wherein the drive member is rotated in a first end of the accommodation tube, and the torque adjustment mechanism is arranged on a second end of the accommodation tube and abuts against the drive member so as to adjust a desired torque value;
wherein the drive member includes a positioning element extending from a first end of the drive member, and the positioning element has an outer diameter more than an outer diameter of the accommodation tube, the positioning element further has an engagement face formed on a first surface of the positioning element adjacent to the drive member; and
wherein a control sleeve is fitted with the first end of the accommodation tube and is moved to a unlock position or a lock position by a user;
wherein when the control sleeve is fixed on the unlock position, a first end of the control sleeve is away from the engagement face so that the drive member is rotated to a desired angle, and the body is operated as a torque wrench;
wherein when the control sleeve is fixed on the lock position, the first end of the control sleeve abuts against the engagement face so that the drive member is not rotated, and the body is operated as a fixed wrench.

2. The switch structure as claimed in claim 1, wherein the accommodation tube includes an outer threaded portion formed the first end thereof, and the control sleeve includes an inner threaded portion formed on an inner wall thereof and configured to screw with the outer threaded portion, such that the control sleeve is moved to the unlock position or the lock position.

3. The switch structure as claimed in claim 1, wherein the control sleeve includes a fixing groove in which a first retaining section, a second retaining section, and a connection section configured to connect with the first retaining section and the second retaining section are formed; wherein the body includes the accommodation tube on which a defining bolt slides, and the defining bolt is inserted into the fixing groove; when the defining bolt slides to the first retaining section, the control sleeve is located on the unlock position; when the defining bolt slides to the second retaining section, the control sleeve is located on the lock position.

4. The switch structure as claimed in claim 1, wherein the fixing groove is defined on the accommodation tube, and the defining bolt is mounted on the control sleeve.

5. The switch structure as claimed in claim 1, wherein the control sleeve includes a threaded orifice configured to screw with a screw bolt, and the screw bolt contacts with the accommodation tube so as to be rotated loosely or tightly, such that the control sleeve is moved to the unlock position or the lock position.

6. The switch structure as claimed in claim 1, wherein a second end of the drive member is inserted into the first end of the accommodation tube and is rotatably fixed in the accommodated tube by a connection bolt.

7. The switch structure as claimed in claim 1, wherein the positioning element further an actuation extension arranged on a second surface thereof away from the drive member.

8. The switch structure as claimed in claim 7, wherein the actuation extension is a column configured to engage with a socket.
